(19) United States
(12) Patent Application Publication
(10) Pub. No.: US 2025/0276254 A1
(43) Pub. Date: Sep. 4, 2025

(54) SALT-REJECTION SOLAR EVAPORATOR SYSTEM AND METHOD

(71) Applicant: KING ABDULLAH UNIVERSITY OF SCIENCE AND TECHNOLOGY, Thuwal (SA)

(72) Inventors: Yu HAN, Thuwal (SA); Kaijie YANG, Thuwal (SA); Tingting PAN, Thuwal (SA); Qiaoqiang GAN, East Amherst, NY (US)

(21) Appl. No.: 18/863,717

(22) PCT Filed: May 3, 2023
(86) PCT No.: PCT/IB2023/054617

§ 371 Date: Nov. 7, 2024

Related U.S. Application Data
(60) Provisional application No. 63/342,781, filed on May 17, 2022.

(51) Int. Cl. B01D 1/00; C02F 1/14

(52) U.S. Cl. CPC B01D 1/0035; C02F 1/14

(57) ABSTRACT

A salt-rejection evaporator system includes a support frame, a mass and heat transport component supported by the support frame, the mass and heat transport component having plural transport layers, and a solar absorber layer located on top of the transport layers. The plural transport layers include plural microchannels that support capillarity, promote a flow of a saline feed toward the solar absorber layer and generate vapors due to heat generated by the solar absorber layer. The solar absorber layer is formed directly on top of the plural transport layers.

### CROSS-REFERENCE TO RELATED APPLICATIONS

This application claims priority to U.S. Provisional Patent Application No. 63/342,781, filed on May 17, 2022, entitled “VERTICALLY ALIGNED MASS TRANSPORT BRIDGES WITH MINIMIZED CONDUCTIVE HEAT LOSS FOR SELF-CLEANING SOLAR DESALINATION,” the disclosure of which is incorporated herein by reference in its entirety.

### BACKGROUND OF THE INVENTION

### Technical Field

Embodiments of the subject matter disclosed herein generally relate to a system and method for direct solar desalination, and more particularly, to a three-dimensional, open architecture for such a system that enables salt-rejection and increased water production efficiency due to plural transport layers.

### Discussion of the Background

Freshwater scarcity is a paramount global challenge, impacting 2.2 billion people, particularly those residing in arid and remote regions, where transporting water over long distances is either costly or impractical. This situation has been exacerbated by climatic change and rapid population growth. Agricultural irrigation and electrical power generation are the two primary consumers of freshwater, accounting for 70% and 15% of global freshwater withdrawals, respectively. However, freshwater production is reliant on energy input, underscoring the critical importance of the water-energy-food nexus in achieving sustainable development. The production of freshwater for drinking and irrigation using renewable energy sources is crucial in mitigating the mounting pressure resulting from escalating demands for water, energy, and food.

As a sustainable desalination technology, direct solar desalination has the advantages of low cost, off-grid capability, and zero carbon footprint, and is particularly useful for remote areas and distributed communities. The solar-to-vapor conversion efficiency for single-stage processes has approached 100% in the past few years. The evaporation rate can even surpass the theoretical limit for exclusive solar-driven evaporation by exploiting the environmental heat. However, high evaporation rates cannot be maintained during the evaporation of saline water (e.g., seawater and concentrated brine discharged from reverse osmosis (RO) facilities) because of the salt accumulation in the system. For instance, commercial solar stills (e.g., Aquamate Solar Still®) cannot work for practical desalination applications because their evaporators cannot be replaced or cleaned, thus resulting in a short lifespan [1].

Recently, innovative strategies, which can be classified into two general categories, (1) hydrophobic light-absorbing layer design and (2) fluid convection enhancement, were developed to address these challenges. For example, the Janus structures having an upper hydrophobic solar-absorber layer and an underlying hydrophilic water-absorbing layer were proposed [2]. In this design, the saline water cannot reach the upper surface because of its hydrophobicity, thereby preventing surface salt accumulation. However, despite the excellent salt rejection capability associated with this design, its energy conversion efficiency is limited by the rapid heat dissipation from the solar absorber to the bulk water underneath. Likewise, although salt rejection can be realized by improving the fluid convection between the evaporation surface and bulk water, the fluid exchange not only removes salt but also takes heat away from the evaporation surface, thereby resulting in a relatively low vapor generation rate [3].

Thus, the paradox between salt rejection and heat loss remains one of the most challenging barriers faced by solar-driven interfacial evaporation strategies and for this reason, there is a need for a new system that is capable of generating high efficiency water production while also achieving salt-rejection so that the new device can operate for a long term without the need to change any of its parts and also without the need to provide external power.

### SUMMARY OF THE INVENTION

According to an embodiment, there is a salt-rejection evaporator system that includes a support frame, a mass and heat transport component supported by the support frame, the mass and heat transport component having plural transport layers, and a solar absorber layer located on top of the transport layers. The plural transport layers include plural microchannels that support capillarity, promote a flow of a saline feed toward the solar absorber layer and generate vapors due to heat generated by the solar absorber layer. The solar absorber layer is formed directly on top of the plural transport layers.

According to another embodiment, there is a solar-driven atmospheric water extraction system that includes a support frame, a mass and heat transport component supported by the support frame, the mass and heat transport component having plural transport layers, a solar absorber layer located on top of the transport layers, and a sorption system in which a bottom of the plural transport layers is located. The plural transport layers include plural microchannels that support capillarity, promote a flow of atmospheric water toward the solar absorber layer, generate vapors due to heat generated by the solar absorber layer, and absorb atmospheric water and the solar absorber layer is formed directly on top of the plural transport layers.

### BRIEF DESCRIPTION OF THE DRAWINGS

For a more complete understanding of the present invention, reference is now made to the following descriptions taken in conjunction with the accompanying drawings, in which:

FIG. 1A is a schematic diagram of a salt-rejection evaporator system having plural transport layers extending upwards, from a saline feed to a solar absorber layer;

FIG. 1B schematically illustrates a mass transport and heat transport through transport paths formed within the transport layers of the salt-rejection evaporator system;

FIG. 2 schematically illustrates the structure of a transport layer of the salt-rejection evaporator system and the transport paths formed inside the transport layer;

FIG. 3 schematically illustrates the structure of a solar absorber layer used by the salt-rejection evaporator system to heat the transported saline feed;

FIGS. 4A to 4C show various views of the salt-rejection evaporator system;

FIG. 5 is a schematic diagram of a salt-rejection evaporator system having plural individual salt-rejection evaporator systems connected to a single support frame;

FIGS. 6A and 6B illustrate various shapes and positions of the transport layers of the salt-rejection evaporator system;

FIGS. 7A to 7D illustrate a method for making the salt-rejection evaporator system of FIG. 1;

FIG. 8 illustrates the ultraviolet, visible, near-infrared (UV-vis-NIR) spectra of the transport layer, the solar absorber layer coated on the transport layers, and a standard irradiation spectrum of AM 1.5 G;

FIG. 9 illustrates salt-rejection evaporator systems having various numbers of transport layers;

FIG. 10 illustrates the evaporation rate corresponding to the salt-rejection evaporator systems of FIG. 9;

FIG. 11 shows various height salt-rejection evaporator systems;

FIG. 12 shows the evaporation rate for different heights of the transport layers in the salt-rejection evaporator system;

FIG. 13 shows the temperature distribution inside the transport layers of the systems of FIG. 11;

FIG. 14 illustrates the mass change curves and evaporation rates of the evaporator system during a time interval of a few days;

FIG. 15 illustrates a real-time temperature variation of the solar absorber layer, environment, bottom of the transport layers, and the saline feed for a test performed over a few days in the real environment;

FIG. 16 illustrates a sorption-based atmospheric water extraction system using plural transport layers; and

FIG. 17 schematically illustrates the temperature gradient through the microchannels of the plural transport layers, and the back flow of the sorption particles.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a salt-rejection solar evaporator system that has an open architecture and includes plural vertical mass transport layers. However, the embodiments to be discussed next are not limited to vertical mass transport layers, but may be applied to non-vertical mass transport layers.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

According to an embodiment, a novel three-dimensional (3D) salt-rejection evaporator system is presented and this new evaporator system achieves stable and efficient water evaporation by enhancing the salt backflow and conductive heat recovery. The evaporator system includes a number of vertically (or non-vertically) aligned mass transfer bridges (MTBs) or simply “transport layers” containing abundant hydrophilic microchannels. In addition to facilitating salt and water transport, the transport layers separate a solar absorber layer from the bulk water (saline feed), thus creating a highly open 3D space through which additional water can be evaporated by conductive heat from the solar absorber layer. The solar-driven vapor generation rate and practical water production performance of this 3D evaporator system were evaluated under laboratory and outdoor conditions and the experimental results demonstrate that the 3D evaporator system can stably and continuously operate without salt accumulation when processing high-salinity water (e.g., 12-14 wt. % NaCl solution and concentrated brine from RO facilities) while achieving a high vapor generation rate of about 1.64 kg/m²/h. A scaled-up solar evaporator system was tested on the top of a building to demonstrate its practical applications. Moreover, a daily water collection rate of about 5 L/m² with a practical solar-water collection efficiency of >40% was demonstrated, better than a previously reported record of about 22% [4]. The 3D solar evaporator system is now discussed herein in more detail with regard to the figures.

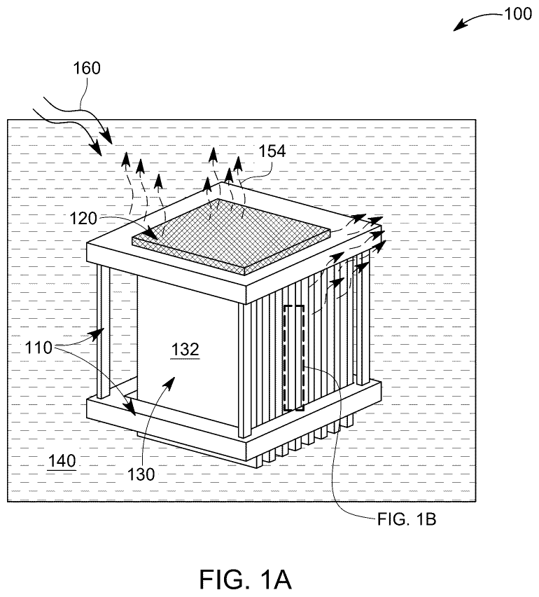

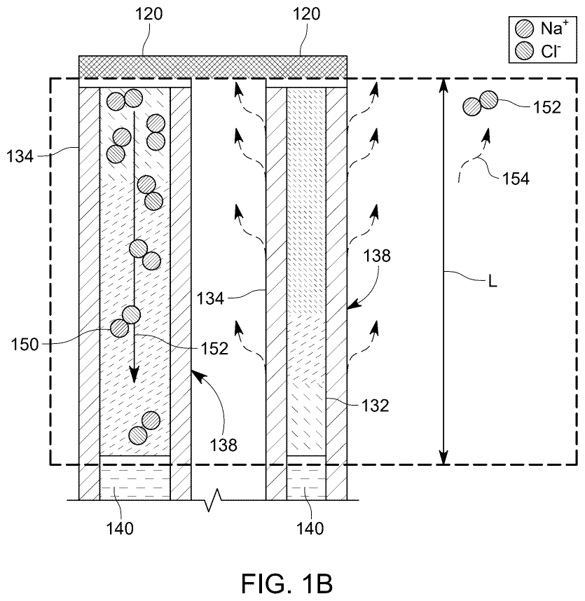

FIG. 1A shows a salt-rejection evaporator system 100 (note that other systems are discussed later) that includes a support frame 110, a solar absorber layer 120 that is supported at the top of the evaporator system, by the support frame 110, and a mass and heat transport component 130 (having plural layer 132). System 100 is configured to be placed on a saline feed 140, for example, sea water, industrial brine, wastewater, etc., which has a certain amount of salt. System 100 may be configured, as discussed later, to float on the saline feed. In one application, system 100 is fixedly placed at a certain location and saline feed 140 is supplied to the system.

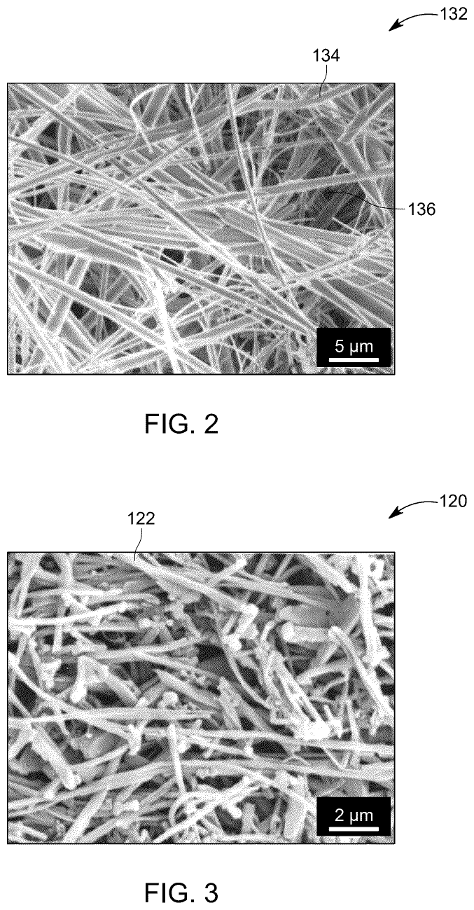

The mass and heat transport component 130 includes, in this embodiment, plural transport layers or bridges or membranes 132 made of fibers or microfibers (for example, glass fibers) 134 as illustrated in FIG. 2. The fibers or microfibers 134 (called herein “the fibers”) may be randomly distributed within transport layer 132 and some of these fibers are interconnected to each other so that the empty spaces 136 between them form mass transport paths or microchannels 138. FIG. 1B shows two microchannels 138 as an example. A large number of microchannels is formed in each transport layer 132. In one application, transport layers 132 may be made of any porous material that has plural pores sized so that the saline feed is pushed by capillarity upwards, toward the solar absorber layer 120. For the capillarity to be present, an average diameter of the microchannel, tube, pore or empty spaces 136 should be 6 mm or less. Thus, any material that has microchannels, tubes, pores, or empty spaces 136 with an average diameter smaller than 6 mm can be used as the material for the transport layer 132. The transport layer 132 may have any thickness and/or width. However, a length of the transport layer 132 is limited as discussed later.

FIG. 1B illustrates the salt backflow 152 through a single mass transport path 138. Note that the path 138 in FIG. 1B is schematically illustrated to be a straight channel. However, in practice, the path 138 is expected to have a more wavy shape, as the path 138 is formed by the empty spaces 136 shown in FIG. 2, and those spaces are not typically aligned along a straight line. However, if the material used for the transport layer 132 is, for example, a type of clay with plural pores, than those pores (paths 138) may be engineered to follow a straight line. The shape of the path 138 can vary in many ways as long as the path 138 extends from the saline feed 140 to the solar absorber 120 and supports capillarity.

FIG. 1B shows that salt molecules 150 travel from the saline feed 140 toward the solar absorber layer 120. As more salt molecules 150 accumulate near the solar absorber layer 120, their concentration at the top of the path 138 increases. The increased concentration of the salt molecules 150 at the top of the path 138 make the salt molecules to travel back toward the saline feed 140, as schematically illustrated by arrow 152 in FIG. 1B. This salt backflow 152 prevents the salt accumulation at the solar absorber layer 120, which is one of the biggest problems of the existing evaporator systems. Because of the presence of the salt backflow 152, the system 100 can function for a long period of time without the need of being cleaned and without the risk of losing its efficiency.

At the same time, part of the heat accumulated at the solar absorber layer 120 diffuses along path 138, toward the saline feed 140. Due to the choice of the vertical length L of the path 138, the heat from the solar absorber layer 120 is essentially entirely transformed into vapor 154 along the path, so that practically no heat reaches the saline feed 140. This is advantageous because the bulk water 140 does not need to be heated and the vapor 154 generated along the path 138 further evaporates the water from the saline feed that circulates through the path. Thus, the arrangement shown in FIG. 1A simultaneously achieves salt rejection from the solar absorber layer 120 and vapor generation through direct heat and heat recycling.

The main source of heat for vapor generation is the light 160 from the sun and this light is transformed into heat by the solar absorber layer 120. For this reason, the solar absorber layer 120 is placed on top of the system 100, to be exposed to the sun as much as possible. The solar absorber layer 120 may be made of various materials, for example, carbon nanotubes (CNT), or partially oxidized carbon nanotubes, or other known materials that transform light into heat. The CNT 122, which are schematically illustrated in FIG. 3, are formed onto the solar absorber layer 120 and this layer is placed on top of the plural paths 138, as schematically indicated in FIG. 1B. Thus, in one embodiment, the solar absorber layer 120 is in direct contact with the top portions of the paths 138.

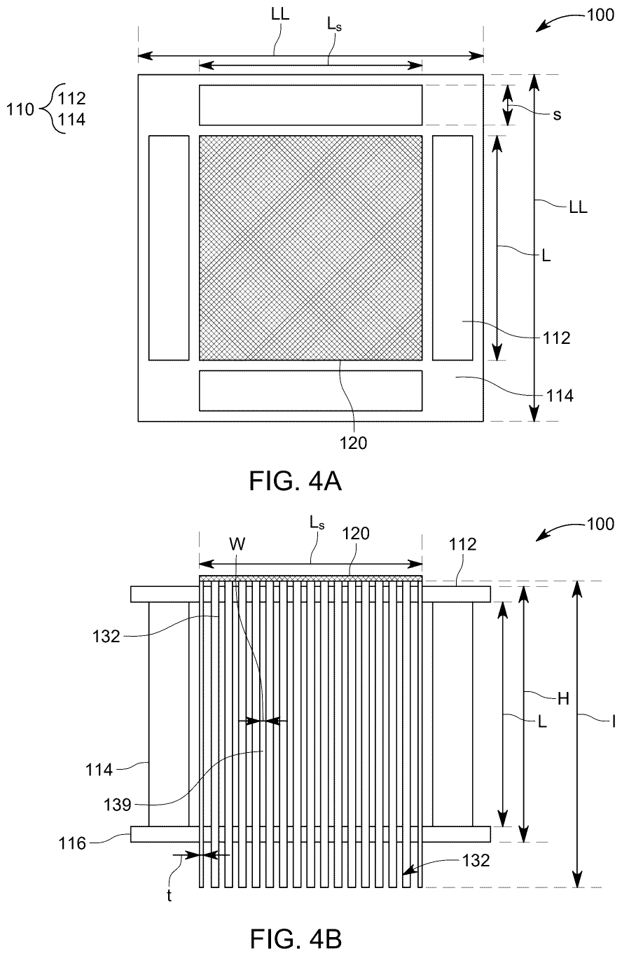

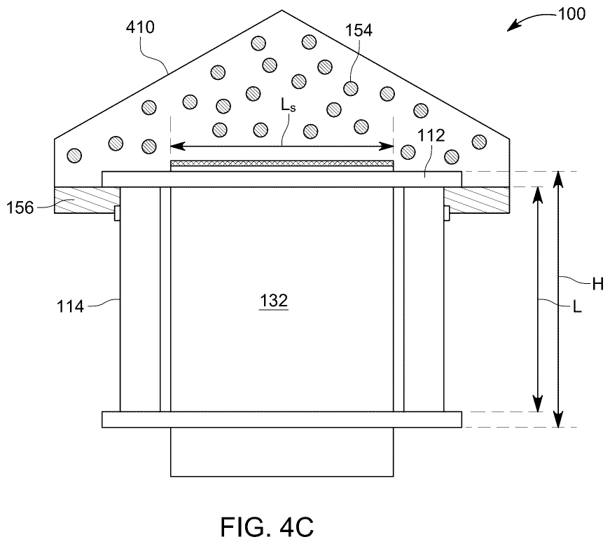

The support frame 110 includes a top body 112 and one or more support pillars 114, as shown in FIGS. 4A to 4C. Although these figures show the top body 112 being supported by four pillars 114, one skilled in the art would understand that only one central pillar may be used, or three or more than four pillars as long as the pillar supports the top body 112 above the saline feed 140. FIG. 4A, which is a top view of system 100, shows the entire solar absorber layer 120 extending over the top body 112, so that no transport layer 132 is visible. FIG. 4B, which is a front view of system 100, shows plural transport layers 132 being supported by the top body 112 and a bottom body 116 so that the plural transport layers 132 are parallel to each other and vertical. Note that each of the top and bottom bodies have corresponding slots that receive transport layers 132. Layers 132 may be simply fitted into the corresponding slots or may be glued to the slots. The number of transport layers 132 can vary, as discussed later. Macrochannels 139 are formed by two adjacent transport layers 132. A width W of such macro channels may be selected to be less than 6 mm, so that capillarity may also appear in the macrochannels 139, not only within the microchannels 138. This is advantageous as the vapors 152 escaping the microchannels 138 directly interact with the saline particles in the macro channels and further generate vapors. At this step the heat lost from the solar absorber layer is recycled as this heat is not lost to the bulk water, but rather it is used to further generate vapors. FIG. 4C shows a side view of system 100, with only one single transport layer 132 being visible. In this embodiment, the solar absorber layer 120 is a square, having a side Ls of about 30 mm, and a side LL of the frame 110 is about 40 mm, with a lateral size S of each pillar 114 being about 5 mm. A height H of the frame 110 is about 35 mm. Note that the term “about” is used in this application to indicate a variation of up to 20% of the reference number that is characterized by the term “about.” A thickness t of the transport layer 132 may be about 0.45 mm. FIG. 4C also shows the addition of a cover 410 around the top part of the transport layers 132, where the vapors 154 are mainly generated. The cover 410 is shown in this embodiment being attached to the pillars 114. However, in a different embodiment, the cover may be attached to the top body 112 or any other part of the support frame 110 or the mass and heat transport component 130. The cover 410 is designed to promote the condensation of the water vapor 154 and generate condensate 156, as schematically illustrated in the figure. The cover 410 may be made of any material that is transparent to the light so that the light can reach the solar absorber layer 120.

FIG. 4B shows an effective length L of one or more of the transport layers 132 being considered to be between the top and bottom bodies 112 and 116 of the support frame 110. In other words, although the actual length l of the transport layers is longer, I>L, as they extend past the bottom body 116, so that when the system 100 is placed above or to float in the saline feed 140, the bottom parts of the transport layers 132 are fully immersed in the feed, the effective length L of the transport layers, for calculation purposes, is considered herein to not be the actual length l, but an effective length.

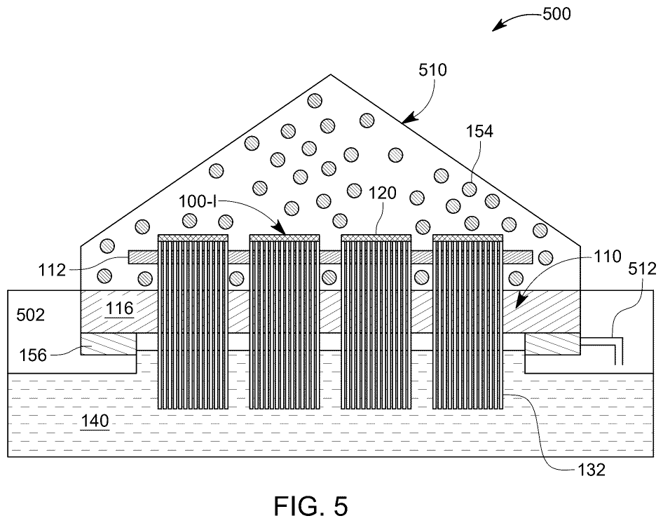

FIG. 5 illustrates a salt-rejection evaporator system 500 that includes plural systems 100-1, where I is an integer equal to or larger than 1, and a common support frame 110 holds all the transport layers 132 of each system 100-1. The bottom body 116 is placed onto a floating component 502, for example, made of a plastic or other material that is lighter than the saline feed 140. In this case, the saline feed 140 may be sea or ocean water and the system 500 may be floating on it. In this embodiment, the top part of transport layers 132 extends past the top body 112, as shown in the figure. Note that in FIGS. 1A, 4B, and 4C, the top of the transport layers 132 is flush with the top body 112. Further, FIG. 5 shows a dome (or cover) 510, which is made of a light material, which covers the entire top portions of the transport layers 132. Dome 510 is made of a material that is transparent to light, so that the solar light reaches the solar absorber layer 120 almost unimpeded. The vapors 154, which are generated in and between the paths 138 of the transport layers 132, raise and condense on the walls of the dome 510, forming the condensate 156, which is collected at the bottom of the dome. An output port 512 may be formed in a wall of the dome 510 to collect the condensate 156, which is essentially desalinated water. While FIG. 5 shows the system 500 including plural systems 100, it is possible to have only one system 100.

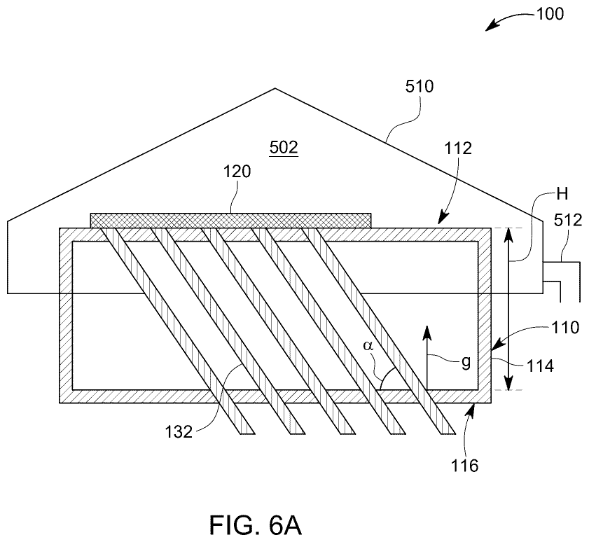

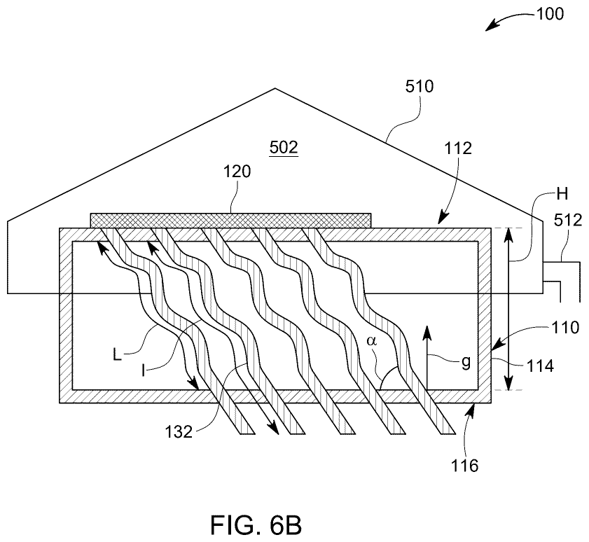

The embodiments discussed above show transport layers 132 being parallel to each other and essentially being arranged to be vertical, i.e., perpendicular to the top or bottom bodies 112 and 116. However, in another embodiment, as illustrated in FIG. 6A, the transport layers 132 are still parallel to each other, but inclined with a non-zero angle α relative to the vertical g. Note that the system 100 is shown herein with the dome 500, thus forming a chamber 502 around the top portions of the transport layers 132. In yet another embodiment, as illustrated in FIG. 6B, transport layers 132 are not flat and extending in a single plane, they are wavy as they extend from the bottom body 116 to the top body 112. Layers 132 may have any shape in this embodiment. It is noted that the height H of the transport layers 132 between the top and bottom bodies 112, 116 remains the same as in the previous embodiments, although the effective length L and the actual length l of these layers is larger than in the previous embodiments.

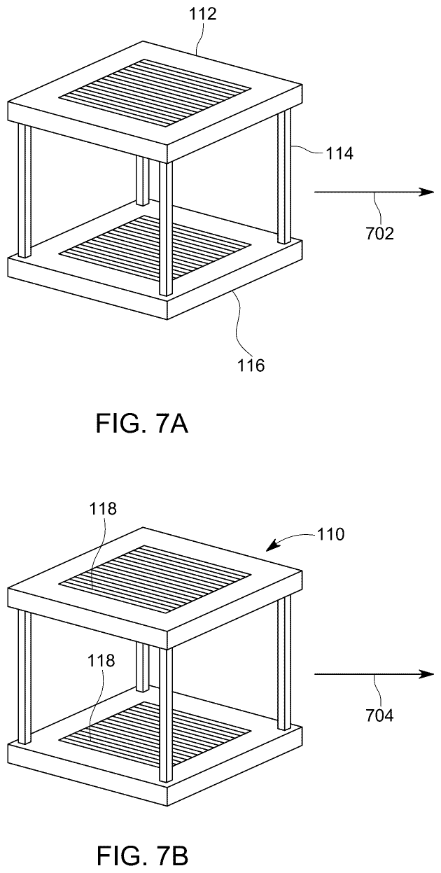

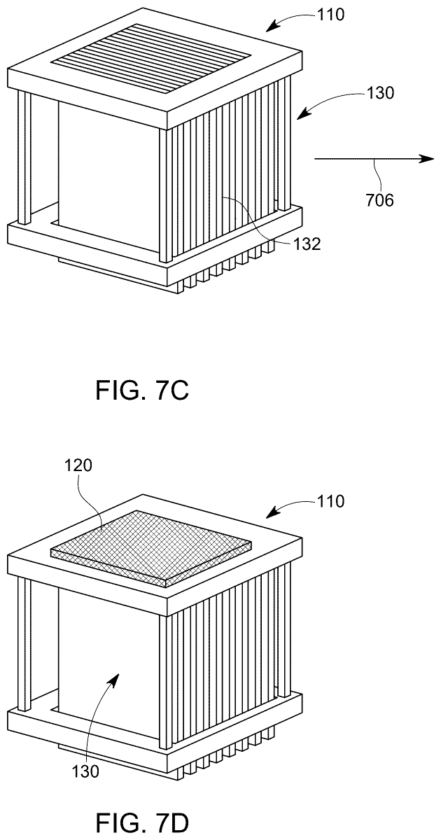

A method for manufacturing the salt-rejection evaporator system 100 is now discussed with regard to FIGS. 7A to 7D. The method starts in FIG. 7A with the manufacturing of the top body 112, pillars 114, and the bottom body 116. In one application, these parts of the support frame 110 are 3D printed. In yet another embodiment, they are made of a polymethyl methacrylate (PMMA) plate via laser cutting. The parts are then bonded in step 702 to obtain the support frame 110 shown in FIG. 7B. Note that each of the top and bottom bodies 112 and 116 have corresponding slots 118 for receiving the transport layers 132. In step 704, transport layers 132 are inserted into the corresponding slots formed in the top and bottom bodies, to form the mass and heat transport component 130. A transport layer 132 may have an effective length L of about 3 cm and a thickness t of about 0.45 mm. In step 706, the solar absorber layer 120 is placed over the top body 112, to be in direct contact with the top of the transport layers 132. If the transport layers 132 are flush with the top body 112, then the solar absorber layer 120 is in direct contact with both the top parts of the transport layers 132 and the top body 112. However, if the transport layers 132 extend past the top body 112, then the solar absorber layer 120 is in direct contact only with the transport layers 132. The solar absorber layer 120 was fabricated in this embodiment by loading partially oxidized CNTs on transport layers 132. The reason for choosing partially oxidized CNTs over pristine CNTs is that their hydrophilicity facilitates the formation of a uniform coating on the transport layers 132. For example, about 3 g of CNTs (diameter: 110-170 nm and length: 5-9 μm) was dispersed in a 120 ml acid mixture (90 ml H2SO4+30 ml HNO3) and reacted at 70° C. for 5 h. The resultant product was collected by filtration and washed until neutralization. Next, a certain amount of partially oxidized CNTs was dispersed in water through ultrasonication and then filtered through a glass fiber membrane. The obtained solar absorber was dried at 60° C. The CNT loading percentage was determined to be ˜11 wt. %.

For the conventional salt-rejection solar evaporation systems, water evaporation is confined to the solar absorber surface, and the salt backflow is accompanied by an undesired heat dissipation from the solar absorber to the bulk water (saline feed), thus resulting in a low evaporation rate. This limitation of the existing devices is solved by the 3D evaporator systems 100/500 because transport layers 132 connect the saline water to the solar absorber layer, they have hydrophilic microchannels that can pump the saline water to the solar absorber layer via a capillary force, and they also promote the flow back of the excessive salt into the saline feed through the brine-filled microchannels (i.e., paths 138) via diffusion and convection, as schematically illustrated in FIG. 1B. The adequate mass transfer via a high density of transport layers 132 ensures a continuous water supply and an efficient salt backflow, thus enabling a unique salt rejection capability. Unlike the conventional salt-rejection systems, where the heat conducted from the solar absorber to the bulk water is simply dissipated and considered “wasted,” the transport layers 132 can efficiently recover this conductive heat to generate additional vapor from the brine flowing through their microchannels 138. The microchannels 138 within the layers 132 and the macrochannels 139 between the spaced layers 132 together form a highly open structure that allows the generated vapor to be easily released from the layers 132's surfaces, in all directions. Thus, by selecting the height of the layers 132 to have a value in a specific range (which is discussed later), the conductive heat can be largely confined within the mass and heat transport component 130 for vapor generation, thereby significantly improving the water evaporation efficiency of the system.

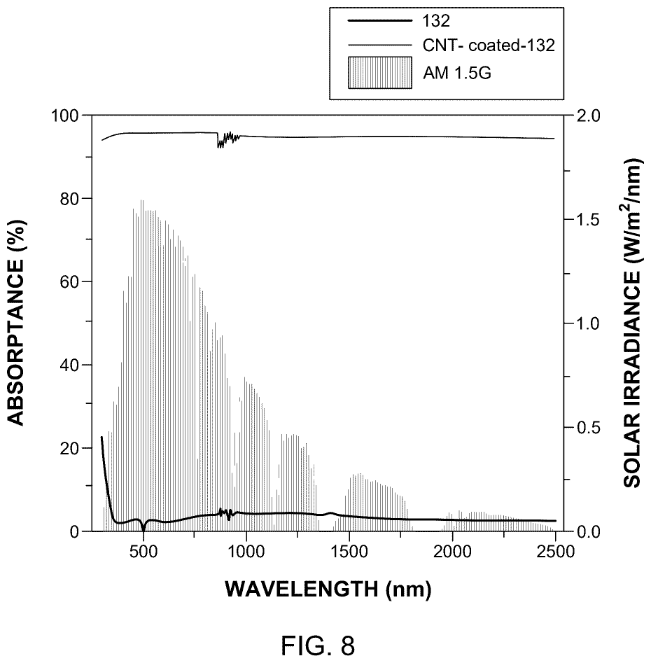

The solar absorber layer 120 of the system 100/500 was found to have a solar absorption of about 96% as shown in FIG. 8 because of the porous fibrous light-trapping structure (see FIG. 3) and the inherent black property of the CNT. Considering their abundant hydrophilic microchannels formed by intertwined glass fibers (see FIG. 2), the glass fibers 136 were selected for making up the layers 132. A glass fiber made transport layer 132 can immediately absorb a water droplet upon touching it because of its high affinity to water. Moreover, vertically aligned layers 132 can pump water to a 25 cm height in 60 min, demonstrating its strong capillary force for water transfer.

The advantages of the system 100/500 discussed above over the existing devices are achieved due to the configuration/structure of the system, but also, in part, due to the effective length L (not the actual length l) of layers 132. The effective length L was determined, in one embodiment, as now discussed. To avoid salt crystallization at or near the solar absorber layer 120, excess salt must be efficiently transported back toward the saline feed 140 to maintain the top surface's salinity below the saturation point. In this system, salt can be rejected via diffusion and convection through the brine-filled microchannels 138 under the driving force of the concentration gradient (osmosis) and gravity. The mass flow rate (J) through the system 100/500 can be described by the diffusion-convection equation as follows:

$$J = {J}_{diff} + {J}_{conv} = n A ε ( \frac{{k}_{d} ( {C}_{evp} - {C}_{0} )}{H} + {k}_{c} ( {ρ}_{evp} - {ρ}_{0} ) ) \qquad ( 1 )$$

where J_{diff} and J_{conv} are the mass flow rate caused by diffusion and convection, respectively; n is the number of layers 132; A, ε, and Hare the cross-section area, porosity, and height of the layers 132, respectively; K_{d} and k_{c} are the diffusion and average convective coefficients of salt, respectively; Cₑᵥₚ and C₀ are the salt concentrations on the evaporation surface and in the bulk saline water, respectively; and ρₑᵥₚ and ρ₀ are the salt solution densities on the evaporation surface and in the bulk saline water, respectively.

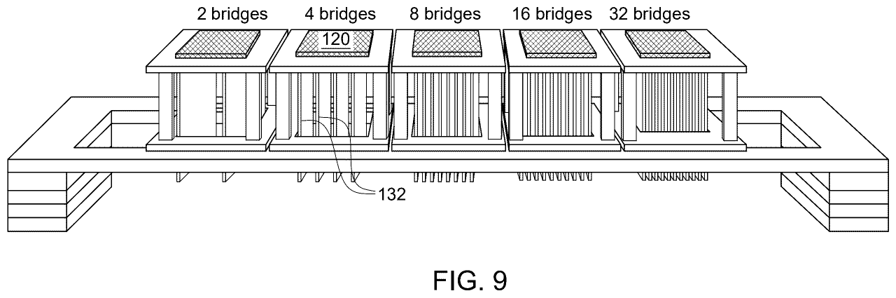

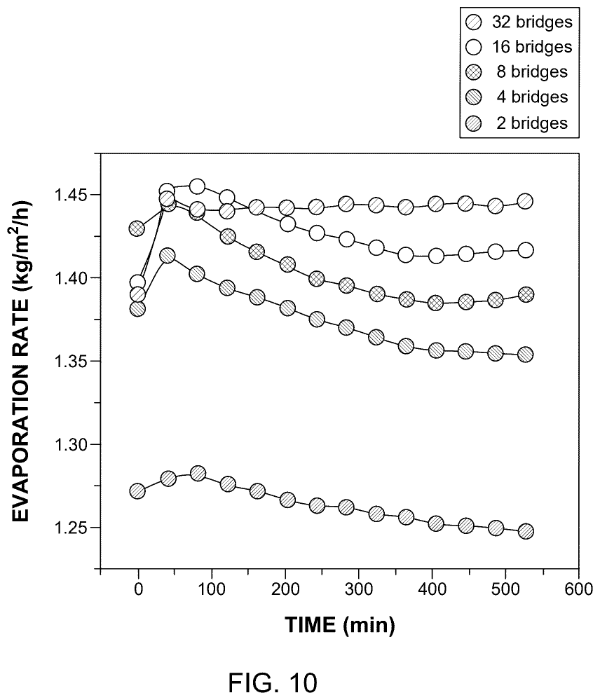

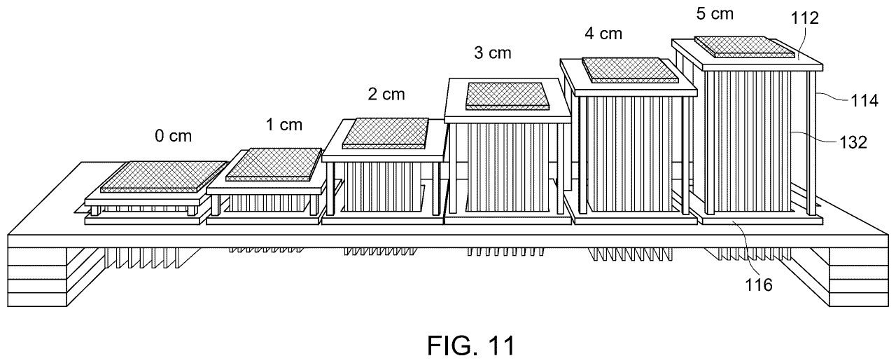

In Equation (1), the mass transport rate is proportional to the number n of transport layers 132. This relation was validated by fabricating systems 100 with varying numbers of transport layers 132, ranging from 2 to 32, as illustrated in FIG. 9. For this experiment, the cross-section area (A) of the transport layer 132 is about 0.135 cm², its height (H) is about 3 cm and its porosity (E) is about 65%. The evaporation for all these samples was evaluated using high-salinity water (10 wt. % NaCl). The evaluation was performed under 1 sun illumination for 12 h. The inventors found that salt crystals massively accumulated on the 2-bridge evaporator surface because of its insufficient mass transfer. This salt accumulation was mitigated with the increase in the transport layers 132 number. For the evaporator system 100 containing 32 layers 132, no salt crystals were observed on the surface, after the 12 h operation. At an insufficient number of transport layers 132 (e.g., 16 layers), the evaporation rate gradually decreased as the vapor generation progressed because of the increased evaporation surface salinity. In this regard, FIG. 10 shows the corresponding mass change curves for the system samples 100 shown in FIG. 9. It is noted that when the number of transport layers 132 reaches a value of about 32, the excess salt can be efficiently rejected to maintain the evaporation surface at a relatively low salinity. Remarkably, the evaporation rate of the 32-transport layers evaporator system was found to be about 1.44 kg/m²/h without degradation during the 12 h operation.

Subsequently, the inventors performed a complementary experiment to further demonstrate the salt backflow introduced by the 32-transport layer evaporator system 100. In this experiment, the evaporator system was placed in a high-concentration saline water (10 wt. % NaCl solution) and exposed to 1 sun illumination, and 1 g of NaCl salt was added on its surface (not shown). It was observed that during vapor generation, the added salt was gradually dissolved and completely removed in about 11 h. This experiment demonstrated that the salt backflow rate of the 32-transport layer evaporator system in the 10 wt. % NaCl solution was higher than the salt generation rate, thus confirming the salt rejection feature of the proposed architecture. When the saline feed's salinity was further increased, to test the maximum applicable salt concentration of this evaporator system, the inventors observed that because of the effects of diffusion and convection, the salt backflow decreased as the salinity (i.e., C₀ and ρ₀) increased, and salt started to crystallize at the edges of the solar absorber after 12 h operation when 14 wt. % NaCl solution was used for the test. Based on the corresponding evaporation rate, the salt backflow along the transport layers 132 was calculated to be about 1.1 g/cm²/h. Interestingly, this unique mass transport feature is intertwined with its heat transport feature, as now discussed.

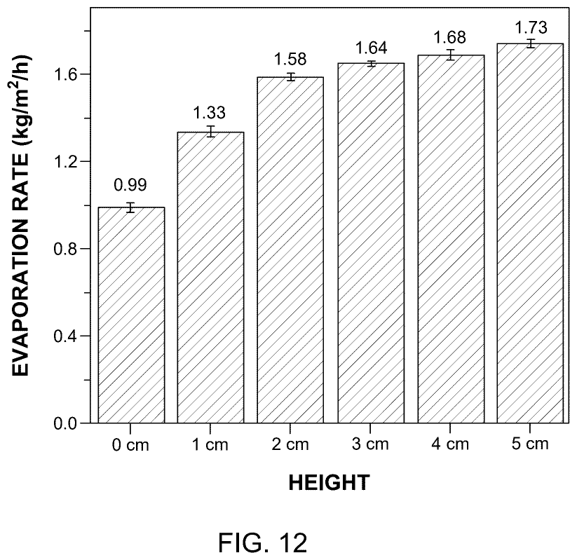

For the heat transport investigation, the inventors fabricated 32-transport layers evaporator systems with different heights, as illustrated in FIG. 11, and evaluated their evaporation performance. Under dark conditions, the evaporator system without transport layers 132 (i.e., transport layer height: 0 cm) exhibited a natural evaporation rate of 0.15 kg/m²/h. The natural evaporation rate increased with the incorporation of the transportation layers due to the increased surface area. Specifically, it linearly increased by about 0.04 kg/m²/h for every 1 cm increase in the height of the transport layers 132. Under 1 sun illumination, the evaporation rate of the evaporator system without transport layers was only 0.99 kg/m²/h because of the massive conductive heat dissipation to the bulk water, as shown in FIG. 12. The transport layers usage considerably promoted solar evaporation. The evaporation rate increased to 1.58-1.73 kg/m²/h when the transport layer height reached 2-5 cm, as also shown in FIG. 12. These values are even higher than the theoretical upper limit for solar evaporation (˜1.44 kg/m²/h), which can be attributed to the natural evaporation contribution. When the transport layers' height exceeded 3 cm, the evaporation rate increased by about 0.04 kg/m²/h for every 1 cm increase in height (see FIG. 12), which was consistent with the result obtained under dark conditions. This consistency suggests that the 3 cm height is sufficient for the transport layers 132 to maximize solar evaporation (note that additional increase in the transport layers height only increases natural evaporation).

The energy loss channels for the evaporation system 100 primarily include conductive heat loss into the bulk water (P_{cond.}), radiative heat loss (P_{rad.}), and convective heat loss to the environment (P_{convec.}). Therefore, the power flux available for evaporation (Pₑᵥₚ) can be described as follows:

$${P}_{evp} = {P}_{solar} - {P}_{cond .} - {P}_{rad .} - {P}_{convec .} , \qquad ( 2 )$$

where the solar energy input Pₛₒₗₐᵣ=αCₒₚₜqᵢ; α is the light absorption coefficient; Cₒₚₜ is the optical concentration; and qᵢ is the direct solar illumination. The conductive heat flux P_{cond.}=k(Tₛₐ−T_{bw})/l, where k is the thermal conductivity; Tₛₐ and T_{bw} are the temperatures of the solar absorber and the bulk water, respectively; and l is the heat conduction path of the transport layer 132, which may be equal to the effective length L of this layer or even longer for the embodiments shown in FIGS. 6A and 6B. The radiative heat flux P_{rad.}=εσ(T₁⁴−T₂⁴), while the convective heat flux P_{convec.}=h(T₁−T₂), ε is the optical emission, ε0 is the Stefan-Boltzmann constant, h is the convection heat transfer coefficient, and T₁ and T₂ are the temperatures of the evaporator and environment, respectively.

The energy loss caused by the heat transfer from the top surface of the solar absorber layer 120 to the saline feed 140 (i.e., P_{cond.}) can be minimized by increasing the height of the transport layer (i.e., l) to confine the conductive heat within the transport layers. This effect was visualized using infrared imaging to display the temperature gradients along the transport layers with different heights. The results showed that the temperature at the bottom of the evaporator was similar to the ambient temperature when the transport layers height reached or exceeded 3 cm.

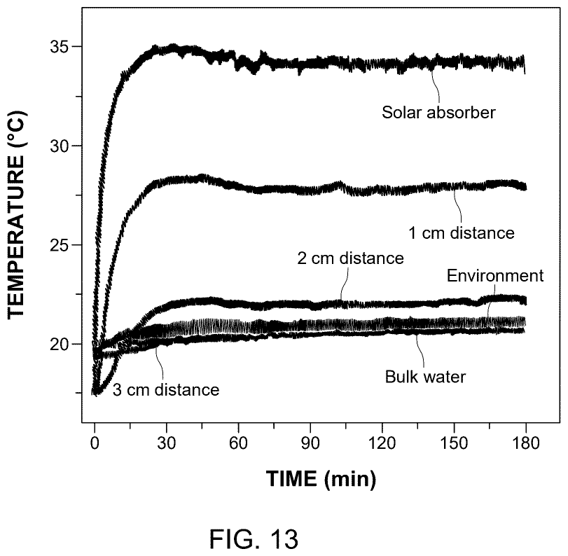

Next, the inventors recorded the internal temperature variation at different distances from the solar absorber layer 120 under solar illumination. The results showed that the temperature stabilized after 60 min, when the internal temperature at 3 cm to the solar absorber layer was similar to that of the surrounding environment (see FIG. 13), indicating that the conductive heat was completely confined in the top 3 cm of the transport layers 132. This confinement effect was also demonstrated by the temperature change of the bulk water. For the evaporator system without transport layers, the bulk water temperature increased from ˜21 to ˜26.2° C. after a 3 h operation due to the continuous heat input; for the evaporator system with 3-cm transport layers, however, the bulk water temperature was maintained at room temperature (˜21.3° C.), thus confirming the suppression of heat dissipation into the saline feed. Thus, the effective length L of the transport layers is selected to suppress heat loss to the saline feed. While this length L is about 3 cm in this embodiment, one skilled in the art would understand that this length can be smaller or larger depending on the type of fibers used in the transport layer, the size of the microchannels, the composition of the saline feed, the ambient temperature, etc.

Novel in the system 100, the confined heat energy is exploited to generate additional vapor from the transport layers 132 surfaces, as schematically illustrated in FIG. 1B, which can be efficiently released via the highly open interbridge spaces. To reveal this additional vapor generation from the external surfaces of the transport layers 132, an evaporator system 100 having 32 transport layers (3 cm high) was used to perform a control experiment. In this experiment, the evaporator body was enclosed with an airtight polypropylene film, thus leaving only the upper surface exposed to the open space for vapor release. After a 3 h operation, many water droplets condensed on the inner film surface, thus confirming that the transport layers released vapor. Compared to the completely open evaporator system, the evaporation rate of the partially enclosed system decreased by about 31%, demonstrating the importance of the open-channel design for enhanced interfacial evaporation.

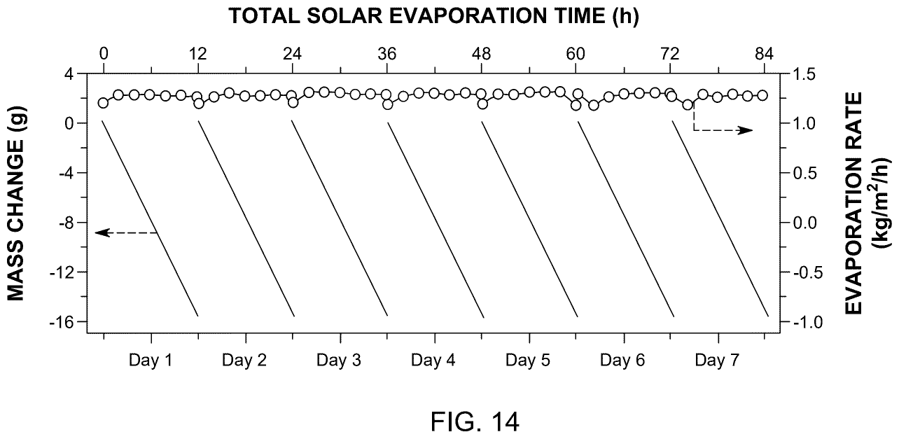

Furthermore, the inventors performed a cycling experiment to evaluate the evaporator system's stability. In each cycle, the evaporator system ran for 12 h under 1 sun illumination and in a dark environment for another 12 h to simulate day and night alternation. FIG. 14 shows that during this long-term test (with 10 wt. % NaCl solution), the mass change of the NaCl solution in each cycle linearly evolved and the evaporation rate stabilized at about 1.44 kg/m²/h. No performance degradation was observed after a seven-day cycling experiment.

Compared to the previously reported salt-rejection evaporators (evaporation rate: from 1.24 to 1.28 kg/m²/h for 10 wt. % NaCl solution) [5, 6, 7], the evaporator system 100 demonstrated a higher evaporation rate under similar conditions due to the heat confinement effect and the natural evaporation contribution. However, high evaporation efficiency alone is not sufficient for water production applications. If the evaporated moisture is not collected, it can only be considered as a pollutant to the environment considering that it has the greatest greenhouse effect among various components in the atmosphere. Water collection, which is equally important as vapor generation, has been largely ignored in many previous studies on salt-rejection evaporators.

Therefore, part of the evaporator system 100 shown in FIG. 1A was enclosed with the transparent cover 410 as shown in FIG. 4C or dome 510 as shown in FIG. 5. The cover and/or dome were made of polymethyl methacrylate (PMMA) plates, and they made the system 100/500 to produce water by condensing the evaporated moisture. The inventors investigated the effects of transport layer number and height on the water production capacity of this system. When the transport layer height was fixed at 3 cm, the amount of collected water increased with the number of transport layers, which is consistent with the observation in the open system, confirming that the enhanced salt backflow facilitates water evaporation. When the transport layer number was fixed at 32, the amount of collected water increased with the transport layer's effective height and reached the maximum at 3 cm, while further increasing the height did not produce more water. These results are consistent with the conclusion above that a 3 cm height is sufficient to confine the conductive heat while further increasing the height only increases natural evaporation that does not contribute to water production. According to three-hour test results, the water production rate of the enclosed evaporator system in the optimal configuration (32 transport layers; 3 cm high) was calculated to be about 0.68 kg/m²/h.

The inventors also investigated the water generation performance of the enclosed system under different salinity conditions using NaCl solutions (3.5 wt. % to 20 wt. %). The results showed that the water production efficiency monotonically decreased from about 0.73 kg/m²/h for 3.5 wt. % NaCl solution to about 0.63 kg/m²/h for 20 wt. % NaCl solution. The relatively low water production efficiency associated with the high-salinity brines is mainly due to their low saturated vapor pressure, and partly due to the decreased photothermic conversion efficiency caused by salt precipitation. For instance, when using brine containing 20 wt. % NaCl, salt precipitation emerged at the periphery of the evaporator system after three hours of testing.

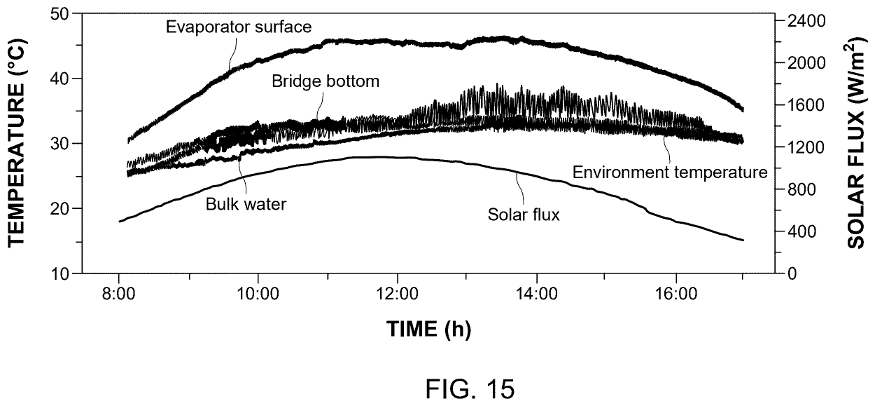

A fabricated solar-driven water generation system 100, having a 15×26 cm evaporator area was tested on the roof of a building and also on the sea surface. In the first test, discharged water from an RO system was used as the source water (salinity: ˜8.7%). The daily evaluation started at 8:00 and ended at 17:00. As shown in FIG. 15, the evaporator surface was heated by solar light to a temperature 4-15° C. higher than the environment. However, the temperature at the transport layer's bottom was almost the same as the environment temperature, indicating that the conductive heat was confined, with only a small amount transferred to the saline feed. Consequently, saline water can be efficiently evaporated and condensed at the cover surface for the water collection. The total collected water was about 175 ml. Based on the evaporator area (390 cm²), the daily water productivity was calculated to be about 5.0 L/m². The inventors measured the ion contents of the water samples to evaluate the water quality. Compared with the discharged water from the RO plant, the ion concentration of the condensed water was reduced by at least four orders of magnitude, thus fully meeting the WHO drinking water requirements.

A continuous test was performed over five days to evaluate the system's performance stability. The daily water collection rate fluctuated in the range of 4.7-5.2 L/m², depending on the specific solar insolation of the day. The corresponding solar-water collection efficiency was 39%-42%. Remarkably, no salt accumulation was observed during this five-day outdoor operation. These results demonstrate the potential of the fabricated evaporator system to extract freshwater from the wastewater discharged by RO plants.

Next, the same evaporation system was tested in a floating configuration in the Red Sea (salt content: ˜4.3%) to demonstrate its potential for practical seawater desalination. The test lasted for five days. It was found that the daily freshwater productivity ranged from 5.0 to 5.8 L/m² with a stable solar-water collection efficiency of 42%-45%, which was consistent with the rooftop test. This freshwater productivity was approximately two times higher than the previous record of the salt-rejection solar evaporator discussed in [5] (˜2.5 L/m² per day). The field test demonstrated a high-performance solar evaporator system that could help in disaster relief or strengthen the resilience of individuals living on boats, coastal areas, or next to saline sources of water.

While the systems 100/500 discussed above use a saline source of water, it is possible, based on a similar architecture, to make a system that uses atmospheric water for producing the condensate. The solar-driven atmospheric water extraction (AWE) is a sustainable technology with great potential for decentralized freshwater supply. However, most AWE systems can only produce water intermittently, under sunlight, due to the cyclic nature of sorption and desorption, and their widespread adoption is hindered by complex design requirements or periodic manual operations. In the following embodiments, a fully passive AWE system is introduced that continuously produces freshwater under sunlight, without the need for additional maintenance or power. By adapting the three-dimensional architecture of system 100, with abundant microfibrous structure to facilitate spontaneous mass transport and efficient photothermal energy utilization, this system can consistently produce, in one embodiment, 0.65 L/m²/h freshwater under 1 sun illumination at 90% relative humidity (RH) and can even function in arid environments with RH as low as 40%. The practical performance of a scaled-up system was tested over a total period of 35 days across two seasons, achieving freshwater production of 2.0-2.9 L/m²/day during a 10-day summer test and 1.0-2.8 L/m²/day during a 25-day fall test, without requiring additional maintenance. These embodiments demonstrate the potential of the system for off-grid, point-of-use irrigation applications by growing plants with atmospherically collected water. This passive AWE system, which uses solar energy to continuously extract moisture from the air for drinking and irrigation, is a promising solution to address the intertwined energy, water and food challenges, especially for remote and water-scarce regions. Note that system 100 uses no external energy, i.e., only the light received from the sun, no batteries, no piezoelectric device, no fuel cell, etc. Thus, the system 100 not only requires no man-made energy, but also has a zero CO₂ footprint as the sun light is directly and totally transformed into heat.

Atmospheric water is an omnipresent natural resource that is estimated to be six times the total freshwater volume in rivers worldwide. Furthermore, its availability is expected to increase due to global warming. Sorption-based AWE using sunlight provides a sustainable strategy for decentralized freshwater supply, which is particularly important for remote, water-stressed regions. Typically, hygroscopic sorbents are employed to extract moisture from the surrounding environment [8, 9]. Once these sorbents become saturated, the system is sealed and exposed to sunlight to initiate the release of the captured water, thus enabling the production of freshwater. Due to the slow kinetics of water capture and release by the sorbent/sorbent bed, many previous systems are limited to only one sorption-desorption cycle per day, with moisture capture occurring at night and water production taking place during the daytime. As a result, the productivity of these systems is inherently constrained by the adsorption capacity of the sorbent. For instance, the reported water productivity for a pioneering system is around 0.77 L/m²/day. Other sorption-based prototypes have produced as little as 0.1 L/kg/day (i.e., one kg of water sorption materials like metal-organic framework can produce only 100 mg water per day).

To overcome these limitations, multiple-cycle systems have been proposed through the development of sorbent/sorbent beds with rapid kinetics. Despite promising developments, the widespread adoption of this technology is still constrained by the high cost of nanomaterials and the challenges associated with scaling up prototypes. Moreover, due to the cyclic nature of the systems, they can only produce water intermittently, under sunlight, and the switching of cycles necessitates the use of active system or labor-intensive operation and auxiliary moving parts, resulting in energy-intensive process and system complexity. To fully exploit the vast potential of AWE, a truly passive and scalable system capable of efficiently and continuously producing freshwater is needed.

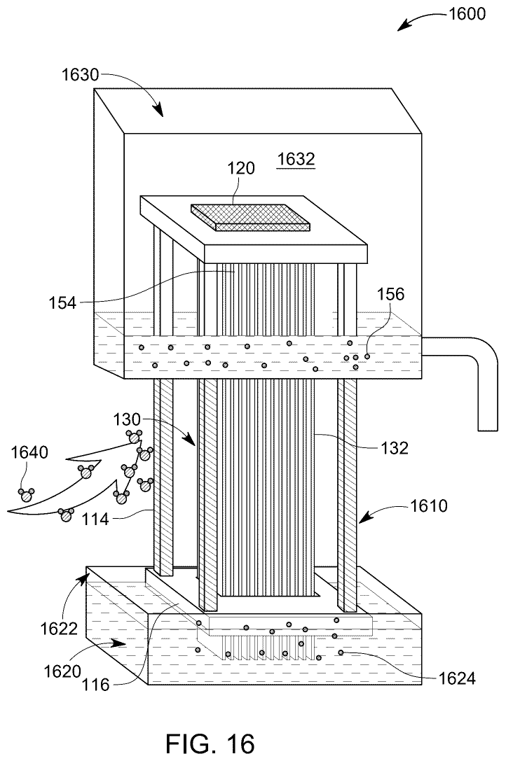

FIG. 16 shows a solar-driven atmospheric water extraction system 1600 that has a support frame 1610, the solar absorber layer 120, the mass and heat transport component 130 having the plural transport layers 132, a sorption system 1620, and a cover 1630. The sorption system 1620 includes a tank 1622 that is configured to hold a sorption liquid 1624. The plural transport layers 132 extend into the sorption liquid 1624 and based on capillarity, push the sorption liquid, along the microchannels 138, toward the solar absorber layer 120. Cover 1630 is located around the top of the plural transport layers 132, similar to the system 500 illustrated in FIG. 5, for forming chamber 1632, for promoting the condensation of the vapors and the collection of the condensate. In one application, cover 1630 is identical to the cover 410 or dome 510.

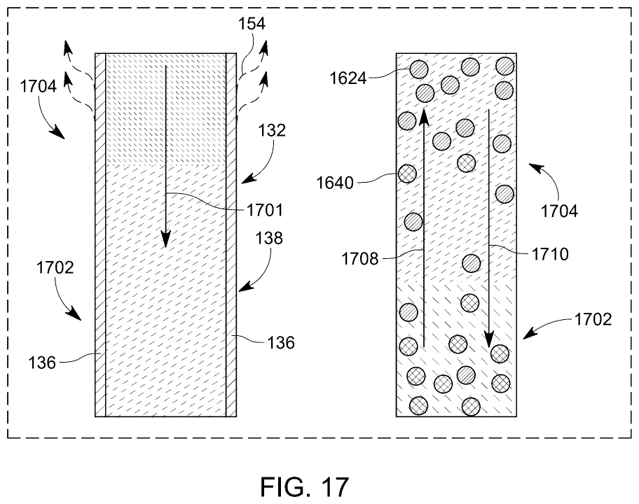

The microchannels 138 (not shown in this figure, but identical to those shown in FIG. 1B of the transport layers 132) are infused with the liquid sorbent 1624. Depending on the temperature distribution, which is schematically illustrated in FIG. 17 by arrow 1701, the transport layers 132 are divided into two functional regions: the room-temperature region 1702, which is exposed to the environment for continuous atmospheric water capture, and the high-temperature region 1704, which is enclosed in the chamber 1632 for freshwater generation. During operation, the room-temperature region 1702 captures atmospheric water and stores the captured water 1640 in the tank 1622, if no sunlight is available. When system 1600 receives sunlight, the solar absorber layer 120 converts the light to heat and generates concentrated vapor 154 in the high-temperature region 1704. Vapor 154 released in the process condenses on the cover 1630′ wall, producing freshwater 156. The captured atmospheric water 1640, stored in tank 1622, is transported to the high-temperature region 1704 via capillarity, as schematically illustrated by arrow 1708, ensuring uninterrupted and efficient vapor generation. Simultaneously, the concentrated liquid sorbent 1624 in the high-temperature region 1704 is transported back to the room-temperature region 1702 through diffusion and convection 1710, where it can continue to capture atmospheric water, as schematically illustrated in FIG. 17. This process results in completely passive and maintenance-free atmospheric water production. By directing the condensed droplets 156 to plant roots (not shown) located next to the system 1600, this system can facilitate off-grid irrigation using only atmospheric water.

In one implementation, the system 1600 has solar absorber layer 120 made by loading partially oxidized carbon nanotubes (CNTs) onto glass fiber membranes (GFM) that form the transport layers 132. Thanks to the light-trapping microstructures and the inherent black property of CNTs, the solar absorptance of the obtained solar absorber can reach ˜96% in the wet state. The GFM was also selected for the fabrication of the transport layers due to its intertwined fibrous structure. At the microscale, the intertwined fibers create abundant capillary microchannels, giving the GFM a strong water transport capability. A particularly noteworthy observation is the linear increase in water uptake with the height of capillary rise in the microchannels 138. This finding implies that nearly all the microchannels are saturated with water, and the interconnected, water-filled channels provide a path for the backflow of sorbents.

In this embodiment, the inventors selected a lithium chloride (LiCl) solution as the hygroscopic liquid sorbent 1624 due to its availability, cost-effectiveness, wide range of applicable relative humidity (RH), and strong water molecule capture capability. The saturated LiCl solution can capture water molecules at RH as low as 15%, and the adsorption capacity reaches ˜2.5 g/g when the RH increases to 90%. Moreover, the water trapped by the LiCl solution can be efficiently released without hysteresis as the RH decreases. Different from the support frame 110 of the system 100, the support frame 1610 has the tank 1622 attached to the bottom body 116, and the poles 114 may be either attached to the body 116, or directly to the tank 1622. A method for making system 1600 is similar to the method for making the system 100, which was discussed in FIGS. 7A to 7D. Thus, the method is not repeated herein.

The AWE system 1600's performance was tested, similar to the system 100. First, system 1600 was tested within a controlled environment. When the system was exposed to solar radiation, the solar absorber layer 120 converts the incoming light into heat energy. This energy is then conducted along the transport layers, creating the temperature gradient 1701. To achieve efficient and stable water production, the number of transport layers has been selected to be 32 and the height of the vapor generation zone 1702 was selected to be about 3 cm. Similarly, to facilitate fast atmospheric water capture kinetics, the height of the atmospheric water capture zone 1704 was selected to be about 5 cm. Thus, the effective height L of the transport layers 132 is about 8 cm in this embodiment, with 3 cm of these layers being located within the cover 1630 and 5 cm of the layers extending between the cover and the bottom body 116. The sorbent solution was selected to be 0.24 g/g LiCl solution at 90% RH. In the absence of sunlight, the system 1600 engaged in atmospheric water capture, with the collected water stored in the tank 1622. As the process continued, the water level in the tank 1622 gradually rose. Upon exposure to sunlight, vapor was released and subsequently condensed to produce condensate water. Simultaneously, a portion of the stored water was transported upward to compensate for the reduced water content in the vapor generation zone 1704, resulting in a corresponding decrease in the water level within the tank 1622. Interestingly, the decrease in the water level was not significant, as the system 1600 continued to capture atmospheric water during the water production process. To highlight this unique feature of the system 1600, i.e., simultaneous water capture and production, the inventors monitored the weight changes of the system and the generated water amount during its operation. After running for 8 h under 1 sun illumination, the system produced about 1.8 ml of water while capturing about 1.5 g of atmospheric water from an environment with a RH of about 65%. Throughout the operation, the water production rate stabilized around 0.22 L/m²/h.

To further assess the AWE potential of the system 1600, the inventors conducted an 8-day consecutive water production evaluation in a laboratory setting under various RH conditions, operating in a maintenance-free mode. In this operating mode, the system operated independently, without requiring any maintenance or adjustment to switch the water capture and water production modes. Each day, the system underwent 16 hours of water capture followed by 8 hours of water production under 1 sun illumination. Throughout the process, the water molecules and sorbents within the system gradually reached a mass transport equilibrium, resulting in stable water production. As RH increased from 60% to 90%, the stabilized water production rate under 1 sun illumination rose from about 0.04 kg/m²/h at 60% RH to about 0.65 kg/m² at 90% RH. This demonstrates the potential of the system to extract fresh water from relatively humid air.

The inventors also assessed the water production of the proposed system in a manual mode, in which the operator manually opened the chamber 1632 during the water atmospheric water capture process to accelerate mass transport. In this operating mode, the system can operate at RH as low as 40%, with stabilized water production rate reaching 0.68 L/m²/h at 90% RH. Consequently, the system can operate at lower RH and is applicable in most parts of the world using this conventional operating mode.

To test the outdoor performance of the AWE system 1600, it was placed on a rooftop. The system operated with water capture occurring during the nighttime. After 24 hours of operation, the weight of the water produced was measured. It generated approximately 95 ml of water. Based on the projected area of the system, the water production was calculated to be about 2.9 L/m²/day.

The inventors further evaluated the water production capability of the system over 35 days across two seasons in Thuwal, Saudi Arabia: 10 days in summer and 25 days in fall. During the summer, with strong sunlight and high temperatures, daily water production ranged between 65-96 ml (equivalent to 2.0-3.0 L/m²/day). This was influenced by both the received solar energy and RH conditions. In the fall, solar intensity and temperature both decreased, yet the prototype remained functional, with daily water production varying between 35 and 90 ml (equivalent to 1.1-2.8 L/m²/day). Due to its completely passive working principle, this system operates spontaneously and continuously to produce water without requiring further maintenance.

Because the AWE system 1600 produces water by extracting it from air and is exposed to environment throughout the entire operation, the collected water may easily be contaminated by airborne pollutants, which were often observed in other atmospheric water harvesting technologies such as fog collection and dew condensation. Therefore, the quality of the water produced by the system was measured. The inventors analyzed the concentrations of ions and microbial cells in the produced water. All ionic indicators were found to be well below the guideline values of WHO. For microbiology, all values of HPC 36° C., total coliforms and Escherichia coli were below the detection limits. The measure for active biomass was below the detection limit of the method, indicating very low or no bacterial presence. Thus, the water quality generated by the system 1600 meets the requirements for drinking and irrigation use.

The AWE system 1600, which requires no bulk water source and minimal installation and maintenance, enables autonomous, point-of-use irrigation. This represents a revolutionary solution for irrigation in semi-arid and arid regions lacking liquid water resources. The disclosed embodiments provide a water generation system that uses plural transport layers for moving water from a source to a solar absorber layer. The transport layers are configured, as discussed in the above embodiments, to ensure salt/sorbent backflow so that the device is maintenance free, and also to reuse the convection heat without heating the water source. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] Liu, Z. et al. Extremely cost-effective and efficient solar vapor generation under nonconcentrated illumination using thermally isolated black paper. Global Challenges 1, 1600003 (2017).
[2] Xu, W. et al. Flexible and salt resistant Janus absorbers by electrospinning for stable and efficient solar desalination. Adv. Energy Mater. 8, 1702884 (2018).
[3] Zhang, Y., Xiong, T., Nandakumar, D. K. & Tan, S. C. Structure architecting for salt-rejecting solar interfacial desalination to achieve high-performance evaporation with in situ energy generation. Adv. Sci. 7, 1903478 (2020).
[4] Ni, G. et al. A salt-rejecting floating solar still for low-cost desalination. Energy Environ. Sci. 11, 1510-1519 (2018).
[5] Chen, X. et al. Sustainable off-grid desalination of hypersaline waters using Janus wood evaporators. Energy Environ. Sci. 14, 5347-5357 (2021).
[6] Zhang, L. et al. Highly efficient and salt rejecting solar evaporation via a wick-free confined water layer. Nat. Commun. 13, 849 (2022).
[7] Xu, N. et al. A water lily-inspired hierarchical design for stable and efficient solar evaporation of high-salinity brine. Sci. Adv. 5, eaaw7013 (2019).
[8] A. LaPotin, H. Kim, S. R. Rao and E. N. Wang. Adsorption-based atmospheric water harvesting: Impact of material and component properties on system-level performance. Accounts of Chemical Research 52, 1588-1597, (2019).
[9] K. Yang, et al. A roadmap to sorption-based atmospheric water harvesting: From molecular sorption mechanism to sorbent design and system optimization. Environ Sci Technol 55, 6542-6560, (2021).

1. A salt-rejection evaporator system comprising:
a support frame;
a mass and heat transport component supported by the support frame, the mass and heat transport component having plural transport layers; and
a solar absorber layer located on top of the transport layers,
wherein the plural transport layers include plural microchannels that support capillarity, promote a flow of a saline feed toward the solar absorber layer and generate vapors due to heat generated by the solar absorber layer, and
wherein the solar absorber layer is formed directly on top of the plural transport layers.

2. The system of claim 1, wherein the plural transport layers are parallel to each other.

3. The system of claim 2, wherein the plural transport layers extend along a direction that is perpendicular to the solar absorber layer.

4. The system of claim 1, wherein the plural transport layers include 32 layers and an effective length of the plural transport layers is about 3 cm.

5. The system of claim 1, wherein the plural transport layers are made of glass fibers and the solar absorber layer is made of carbon nanotubes.

6. The system of claim 1, wherein an effective length L of the plural transport layers is selected so that a temperature increase generated at the solar absorber layer, due to the transformation of light into heat, is not heating a saline feed at a bottom of the plural transport layers.

7. The system of claim 1, wherein heat generated by the solar absorber layer heats a saline feed that flows through microchannels of the plural transport layers and generates vapors.

8. The system of claim 7, further comprising:
a cover located over a top portion of the plural transport layers, the cover being configured to condensate the vapors generated between the plural transport layers.

9. The system of claim 1, wherein the support frame includes a top body, a bottom body, and one or more pillars that separate the top body from the bottom body.

10. The system of claim 9, further comprising:
a floating element configured to float the plural transport layers on the saline feed so that a bottom part of the plural transport layers is fully located within the saline feed.

11. The system of claim 1, wherein the plural transport layers include plural microchannels that promote capillarity, and the plural microchannels act as a conduit for salt backflow from the solar absorber layer toward a bottom part of the plural transport layers.

12. The system of claim 1, wherein the plural transport layers are configured to generate vapors and a condensate of these vapors is generated using only solar light.

13. A solar-driven atmospheric water extraction system comprising:
a support frame;
a mass and heat transport component supported by the support frame, the mass and heat transport component having plural transport layers;
a solar absorber layer located on top of the transport layers; and
a sorption system in which a bottom of the plural transport layers is located,
wherein the plural transport layers include plural microchannels that support capillarity, promote a flow of atmospheric water toward the solar absorber layer, generate vapors due to heat generated by the solar absorber layer, and absorb atmospheric water; and
wherein the solar absorber layer is formed directly on top of the plural transport layers.

14. The system of claim 13, wherein the sorption system includes a sorption fluid that travels through the plural transport layers toward the solar absorber layer, and the sorption fluid absorbs the atmospheric water from atmosphere and carries the atmospheric water through the plural transport layers toward the solar absorber layer.

15. The system of claim 13, wherein the plural transport layers are parallel to each other, and the plural transport layers extend along a direction that is perpendicular to the solar absorber layer.

16. The system of claim 13, wherein the plural transport layers include 32 layers and the plural transport layers have a top water evaporation zone that is about 3 cm tall, for generating water vapor, and a bottom atmospheric water capture zone that is about 5 cm tall, for capturing the atmospheric water.

17. The system of claim 13, wherein heat generated by the solar absorber layer heats the sorption liquid and the atmospheric water, which flow through microchannels of the plural transport layers, and generates vapors.

18. The system of claim 17, further comprising:
a cover located over a top portion of the plural transport layers, the cover being configured to condensate the vapors generated between the plural transport layers.

19. The system of claim 13, wherein the support frame includes a top body, a bottom body, and one or more pillars that separate the top body from the bottom body.

20. The system of claim 13, wherein the plural microchannels act as a conduit for sorption particles backflow, from the solar absorber layer toward a tank of the sorption system.
